(19) United States
(12) Patent Application Publication
(10) Pub. No.: US 2026/0086543 A1
(43) Pub. Date: Mar. 26, 2026

(54) SYSTEMS AND METHODS FOR MONITORING THIN FILM SUBSTRATE MANUFACTURING PROCESSES

(71) Applicant: Toyota Research Institute, Inc., Los Altos, CA (US)

(72) Inventor: Brian David Storey, Newton, MA (US)

(73) Assignees: Toyota Research Institute, Inc., Los Altos, CA (US); Toyota Jidosha Kabushiki Kaisha, Toyota-shi (JP)

(21) Appl. No.: 18/894,683

(22) Filed: Sep. 24, 2024

(51) Int. Cl. G05B 19/418; H01M 10/04; H01M 10/0525

(52) U.S. Cl. CPC G05B 19/41875; G05B 2219/32368; H01M 10/0409; H01M 10/0525

(57) ABSTRACT

Systems, methods, and other embodiments described herein relate to monitoring the manufacturing processes of thin film substrates to detect anomalies in the manufacturing process. In one embodiment, a method includes identifying, from an output of the sensor, a tension-induced feature on a surface of the thin film substrate that is under tension in a manufacturing system. The method also includes detecting that the manufacturing system is in a fault state based on a characteristic of the tension-induced feature and executing a remedial action responsive to the manufacturing system being in the fault state.

### TECHNICAL FIELD

The subject matter described herein relates, in general, to the manufacturing of thin film substrates and, more particularly, to monitoring a manufacturing system that handles thin film substrates to reduce manufacturing variation and promote high-quality thin film substrate processes and products.

### BACKGROUND

Lithium-ion batteries power many electronic devices used daily. Lithium-ion batteries can be found in smartphones, laptop computers, audio-visual equipment, and many other consumer electronic products. Lithium-ion batteries may also be used to power electric vehicles and hybrid vehicles.

In general, a lithium-ion battery is made up of an anode, a cathode, and a separator. The anode, cathode, and separator are thin film substrates layered together. During battery charge and discharge, lithium ions move between the anode and cathode through the separator. Specifically, during battery discharge, when the battery is powering a device such as an electric vehicle, the anode releases the lithium ions to the cathode through the separator. This creates free electrons in the anode and a flow of electrons towards the cathode through the load (not the separator), thus powering the device. The lithium ions travel to the cathode through the separator. When the battery is being recharged, the reverse operation occurs where the cathode releases the lithium ions collected during use, creating free electrons in the cathode and a flow of electrons back towards the anode through the electrical circuit. The lithium ions migrate towards the anode through the separator. This re-sets the battery to power the load (e.g., smartphone, laptop computer, audio-visual equipment, or vehicle, among others).

### SUMMARY

In one embodiment, example systems and methods relate to a manner of improving the manufacturing uniformity of thin film substrates.

In one embodiment, a thin film monitoring system for enhancing the quality of thin film fabrication is disclosed. The thin film monitoring system includes one or more processors and a memory communicably coupled to the one or more processors. The memory stores instructions that, when executed by the one or more processors, cause the one or more processors to identify, from an output of a sensor directed towards a thin film substrate, a tension-induced feature on a surface of the thin film substrate that is under tension in a manufacturing system. The memory also stores instructions that, when executed by the one or more processors, cause the one or more processors to 1) detect that the manufacturing system is in a fault state based on a characteristic of the tension-induced feature and 2) execute a remedial action responsive to the manufacturing system being in the fault state.

In one embodiment, a non-transitory computer-readable medium for monitoring the processing of thin film substrates in a manufacturing operation and including instructions that, when executed by one or more processors, cause the one or more processors to perform one or more functions is disclosed. The instructions include instructions to identify, from an output of a sensor directed towards a thin film substrate, a tension-induced feature on a surface of the thin film substrate that is under tension in a manufacturing system. The instructions also include instructions that, when executed by the one or more processors, cause the one or more processors to 1) detect that the manufacturing system is in a fault state based on a characteristic of the tension-induced feature and 2) execute a remedial action responsive to the manufacturing system being in the fault state.

In one embodiment, a method for monitoring the processing of thin film substrates in a manufacturing operation is disclosed. In one embodiment, the method includes identifying, from an output of a sensor directed towards a thin film substrate, a tension-induced feature on a surface of the thin film substrate that is under tension in a manufacturing system. The method also includes 1) detecting that the manufacturing system is in a fault state based on a characteristic of the tension-induced feature and 2) executing a remedial action responsive to the manufacturing system being in the fault state.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a manufacturing system that assembles thin film substrates into a lithium-ion battery cell and an associated thin film monitoring system.

FIG. 2 illustrates one embodiment of a thin film monitoring system that is associated with identifying manufacturing system defects with respect to the handling of thin film substrates.

FIG. 3 illustrates one embodiment of a thin film monitoring system that is associated with identifying manufacturing system defects with respect to the handling of thin film substrates.

FIG. 4 illustrates an example of an expected tension-induced feature of a thin film substrate.

FIGS. 5A-5F illustrate examples of fault-indicating tension-induced surface features of a thin film substrate.

FIG. 6 illustrates a flowchart for one embodiment of a method that is associated with identifying manufacturing system defects with respect to the handling of thin film substrates.

FIG. 7 illustrates one embodiment of a machine-learning thin film monitoring system.

### DETAILED DESCRIPTION

Systems, methods, and other embodiments associated with improving the manufacturing of the thin film substrates used in many modern electronic devices and vehicles are disclosed herein. As previously described, lithium-ion batteries are found in many devices. In one particular example, lithium-ion batteries may replace lead-acid batteries in internal combustion engine (ICE) vehicles. In electric vehicles, lithium-ion batteries may replace the engine as the source of propulsion for the vehicle. As described above, a lithium-ion battery generates electron flow via the movement of lithium ions between an anode and a cathode through a separator. Specifically, during battery discharge, when the battery is powering a device, such as an electric vehicle, the anode releases the lithium ions to the cathode through the separator. This creates free electrons in the anode and a flow of electrons towards the cathode. The separator blocks the flow of the electrons through the separator of the battery. The electrons instead flow through an electrical circuit that passes through the load. This migration of electrons, or current, powers electronic devices and vehicles.

When the battery is being re-charged, the reverse operation occurs where the cathode releases the lithium ions collected during use, creating free electrons in the cathode and a flow of electrons back towards the anode through the electrical circuit (i.e., not through the separator), thus re-setting the battery to subsequently power the load (e.g., smartphone, laptop computer, audio-visual equipment, or vehicle among others).

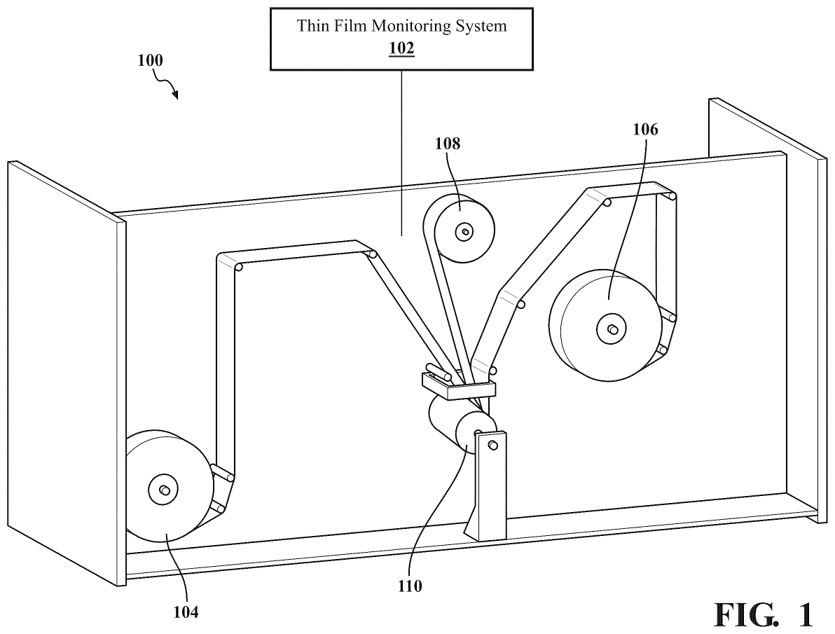

The anode, cathode, and separator of the lithium-ion battery are thin film substrates with a thickness of 0-100 microns (e.g., 10-20 microns). For example, the anode may be a thin copper film coated with graphite. The cathode may be formed of another metal, such as aluminum, coated with a lithium compound such as lithium cobalt oxide (LiCoO₂), lithium manganese oxide (LiMn₂O₄), lithium iron phosphate (LiFePO₄), and lithium nickel manganese cobalt oxide (LiNoMnCoO₂), among others. The separator may be a thin, porous polymer film substrate. Rolls of these substrates are loaded into a manufacturing system, unwound, combined in a layered fashion, and re-rolled to form a lithium-ion battery cell. FIG. 1 depicts a manufacturing system that combines and rolls the thin film layers of the lithium-ion battery. The manufacturing system may include several tension rollers that position the thin film layers during the manufacturing operations. These tension rollers also maintain tension on the thin films as they are wound together.

During this winding operation, some manufacturing complications, such as web breakage and misalignment, may compromise the performance, lifespan, and safety of the lithium-ion battery cells. Web breakage occurs when the thin film substrates get tangled and cause a jam. Web breakage may result in reduced final product output, raw material waste as the jammed thin film substrate is discarded, manufacturing downtime as the jam is addressed, and manufacturing equipment damage.

Misalignment occurs when the thin film layers do not align correctly, for example, with one layer sticking out over the edge of another layer. Misalignment can result in poor battery performance and safety issues and may result in manufacturing downtime as the tension rollers are re-calibrated. As other examples, if the tension within the manufacturing system is too small, the internal resistance and shell entry rate of a lithium-ion battery cell may be negatively impacted. Too much tension may increase the likelihood of a short circuit or electrode fracture.

These and other manufacturing defects may arise if the tension maintained by the tension rollers is too great, too low, or uneven. Maintaining proper tension throughout the manufacturing process may enhance battery cell performance, lifespan, and consistency in the fabrication and performance of different lithium-ion battery cells.

Accordingly, the present specification describes systems and methods that detect when the tension of the thin film substrate (e.g., a cathode substrate, an anode substrate, or a separator substrate) is outside of a target range (i.e., where battery performance, manufacturing consistency, and safety are impacted to a threshold degree). Specifically, when tension is applied to a thin film in a longitudinal direction, the thin film stretches in the longitudinal direction, which contracts the thin film in a lateral direction. Relics of the longitudinal tension manifest as ripples, ridges, waves, and other tension-induced features on the surface of the thin film substrate. The thin film monitoring system of the present specification analyzes these tension-induced features (e.g., ripples, ridges, waves, etc.) to determine whether such differ from what is expected by an amount that indicates the manufacturing system is in a fault state where remedial action is recommended to ensure battery performance, safety, and consistency. That is, a manufacturing system may be deemed to be in a fault state when the tension applied to a thin film substrate is too high, too low, or asymmetric.

Specifically, the thin film monitoring system includes a number of sensors, such as high-speed cameras, that are set up within the manufacturing system at different locations to capture images of the different thin film substrates as they are fed through the manufacturing system. These sensors capture images of the thin film substrate. A processor of the thin film monitoring system analyzes the images to identify longitudinal patterns of lines where the film buckles from the tension. As described above, it may be that a particular pattern of defined ridges/lines exists within the film when under proper tension between rollers. However, when the tension varies, the pattern in the film changes. When the tension becomes too great or too low (as defined by a target tension range) or asymmetric, the pattern changes, for example, by having additional ridges, differently shaped or sized ridges, or different ridge angles. The system can detect these differences and may perform various actions in response. The actions may include generating alerts for manual adjustment, pausing or stopping the manufacturing system, automatically adjusting the tension, etc.

In further aspects, the thin film monitoring system may implement a machine-learning approach that analyzes the sensor data and generates determinations about the tension. This may involve the use of a convolutional neural network, or another network, that processes the image data, identifies the ridges, and determines whether the ridges vary from an expected form. In this way, the disclosed systems, methods, and other embodiments improve thin film processing by detecting variations in tension within the thin films and adapting the manufacturing system accordingly or generating a notification about the condition in order to improve manufacturing. Through this monitoring, the manufacturing system may maintain tighter manufacturing tolerances, improve manufacturing consistency across multiple products, and enhance battery performance, lifespan, and safety.

It should be noted that while the manufacturing of batteries is discussed, this monitoring approach may further extend to other manufacturing processes that use similar raw materials.

Turning now to the figures, FIG. 1 illustrates one embodiment of a manufacturing system 100 that assembles thin film substrates into a lithium-ion battery cell and an associated thin film monitoring system 102. It will be appreciated that for simplicity and clarity of illustration, where appropriate, reference numerals have been repeated among the different figures to indicate corresponding or analogous elements.

As described above, thin film substrates may be assembled to form a lithium-ion battery cell 110. Specifically, a manufacturing system 100, such as that depicted in FIG. 1, includes a system with a number of tension rollers to combine an anode thin film substrate 104, a cathode thin film substrate 106, and a separator thin film substrate 108 into a lithium-ion battery cell 110.

As described above, the anode thin film substrate 104 may be a thin copper film (e.g., between 10-20 microns) coated with graphite. The cathode thin film substrate 106 may be a thin aluminum film (e.g., between 10-20 microns) coated with a lithium compound such as lithium cobalt oxide (LiCoO₂), lithium manganese oxide (LiMn₂O₄), lithium iron phosphate (LiFePO₄), and lithium nickel manganese cobalt oxide (LiNoMnCoO₂), among others. The separator thin film substrate 108 may be a thin porous polymer film. Rolls of these substrates are loaded into a manufacturing system 100, unwound, combined in a layered fashion, and re-rolled to form a lithium-ion battery cell 110. While particular reference is made to particular thin film substrates and particular materials of the thin film substrates, the manufacturing system 100 may combine different thin film substrates, or anode, cathode, and separator thin film substrates of different materials, to form a variety of products including lithium-ion battery cells 110.

Specifically, each thin film substrate may be loaded onto a spool of the manufacturing system 100. The manufacturing system 100 then unwinds the substrates from its roll and passes the thin film substrates by numerous tension rollers to a location where the substrates are joined to form the lithium-ion battery cell 110. For example, the substrates may be fed onto a rotating core under tension such that each substrate layer is wound tightly and evenly. Once a desired dimension, e.g., the diameter of the lithium-ion battery cell 110, is reached, the manufacturing system 100 trims the substrates and seals the lithium-ion battery cell 110. That is, the manufacturing system 100 winds the thin film substrates together to form a lithium-ion battery cell 110, which may be cylindrical, as depicted in FIG. 1.

Note that while a particular manufacturing system 100 is depicted, which winds the thin film substrates to form a cylindrical lithium-ion battery cell 110, the thin film monitoring system 102 may be utilized in other manufacturing systems that process thin film substrates, such as systems that form other types of lithium-ion battery cells, such as planar lithium-ion battery cells, or other products that include thin film substrates.

In some examples, the finished product performance and safety may be related to manufacturing precision. As described above, if the thin film substrates are not wound correctly (e.g., outside of the target tension range or improperly aligned), the lithium-ion battery cell 110 may malfunction or fail. Improper tension may also lead to complications in the manufacturing process, which can result in downtime as the complication is remedied. For example, it may be that the target winding tension is between 0.05 and 0.20 megaPascals (MPa). Winding tensions less than 0.05 MPa or greater than 0.20 MPa may result in a defect in the product that, as noted above, may lead to unsafe, ineffective, or inconsistent battery performance. In addition to potentially negatively impacting the finished product, improper tension may negatively impact the manufacturing operation by, for example, causing jams in the substrate path, misalignments between joined layers, and/or tearing of the thin film substrates.

Accordingly, the thin film monitoring system 102 may be implemented within the manufacturing system 100 to ensure proper tensioning of the various thin film substrates, such as the anode thin film substrate 104, the cathode thin film substrate 106, and the separator thin film substrate 108 that may be combined to form a lithium-ion battery cell 110. Again, as described above, while the thin film monitoring system 102 is particularly described as monitoring the thin film substrates that are used to form a lithium-ion battery cell 110, the thin film monitoring system 102 may be implemented to monitor the processing of thin film substrates in other applications, such as in the use of other types of thin film substrates being incorporated into other consumer products.

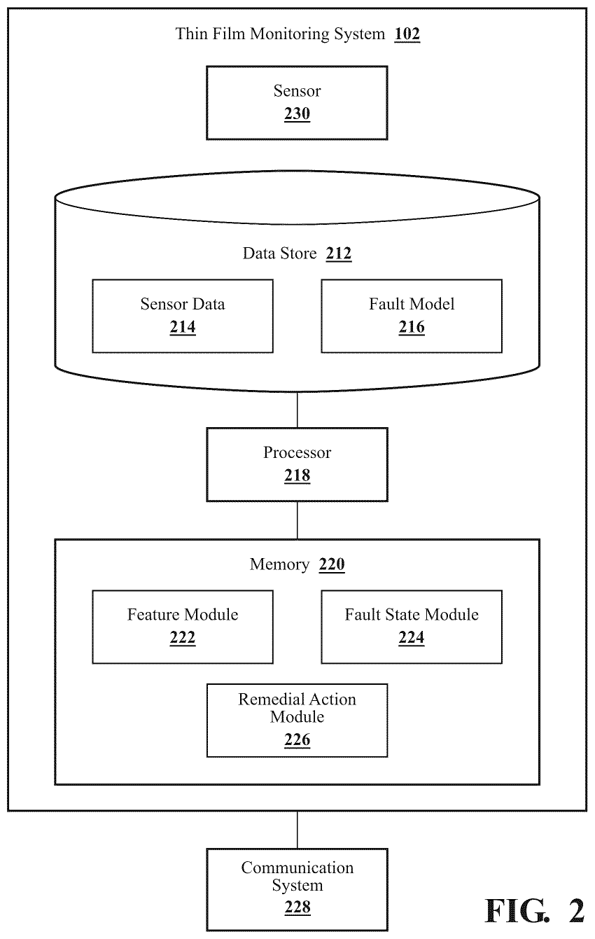

FIG. 2 illustrates one embodiment of a thin film monitoring system 102 that is associated with identifying manufacturing system 100 defects with respect to the handling of thin film substrates. The thin film monitoring system 102 is shown as including a processor 218. In one or more arrangements, the processor(S) 218 can be a primary/centralized processor of the thin film monitoring system 102 or may be representative of many distributed processing units. For instance, the processor(S) 218 can be an electronic control unit (ECU). Alternatively, or additionally, the processor(S) 218 include a central processing unit (CPU), an application-specific integrated circuits (ASIC), a microcontroller, a system on a chip (SoC), and/or other electronic processing unit. As will be discussed in greater detail subsequently, the manufacturing system 100, in various embodiments, may be implemented as a cloud-based service.

In one embodiment, the thin film monitoring system 102 includes a memory 220 that stores a feature module 222, a fault state module 224, and a remedial action module 226. The memory 220 is a random-access memory (RAM), read-only memory (ROM), a hard-disk drive, a flash memory, or another suitable memory for storing the modules 222, 224, and 226. In alternative arrangements, the modules 222, 224, and 226 are independent elements from the memory 220 that are, for example, comprised of hardware elements. Thus, the modules 222, 224, and 226 are alternatively ASICs, hardware-based controllers, a composition of logic gates, or another hardware-based solution.

In at least one arrangement, the modules 222, 224, and 226 are implemented as non-transitory computer-readable instructions that, when executed by the processor 218, implement one or more of the various functions described herein. In various arrangements, one or more of the modules 222, 224, and 226 are a component of the processor(S) 218, or one or more of the modules 222, 224, and 226 are administered on and/or distributed among other processing systems to which the processor(S) 218 is operatively connected.

Alternatively, or in addition, the one or more modules 222, 224, and 226 are implemented, at least partially, within hardware. For example, the one or more modules 222, 224, and 226 may be comprised of a combination of logic gates (e.g., metal-oxide-semiconductor field-effect transistors (MOSFETs)) arranged to achieve the described functions, an ASIC, programmable logic array (PLA), field-programmable gate array (FPGA), and/or another electronic hardware-based implementation to implement the described functions. Further, in one or more arrangements, one or more of the modules 222, 224, and 226 can be distributed among a plurality of the modules described herein. In one or more arrangements, two or more of the modules described herein can be combined into a single module.

In one embodiment, the thin film monitoring system 102 includes the data store 212. The data store 212 is, in one embodiment, an electronic data structure stored in the memory 220 or another data storage device and that is configured with routines that can be executed by the processor 218 for analyzing stored data, providing stored data, organizing stored data, and so on. Thus, in one embodiment, the data store 212 stores data used by the modules 222, 224, and 226 in executing various functions.

The data store 212 can be comprised of volatile and/or non-volatile memory. Examples of memory that may form the data store 212 include RAM, flash memory, ROM, PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 212 is a component of the processor(S) 218. In general, the data store 212 is operatively connected to the processor(S) 218 for use thereby. The term “operatively connected,” as used throughout this description, can include direct or indirect connections, including connections without direct physical contact.

The data store 212 may include sensor data 214 from which the tension-induced features on the surface of a thin film substrate may be identified and, in some cases, classified. For example, as described above, the thin film monitoring system 102 may include, or be coupled to, a sensor 230 directed towards the thin film substrate. The sensor 230 captures data associated with the thin film substrate that travels under tension through the manufacturing system 100.

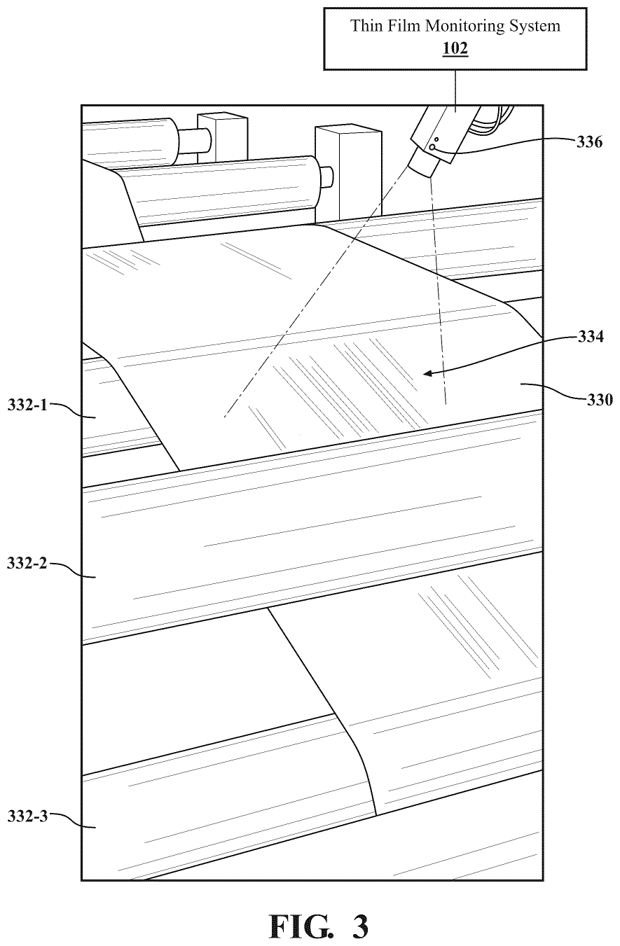

The sensor 230 may take a variety of forms. For example, the sensor 230 may be a high-speed camera, an infrared camera, a thermal imaging camera, a monocular camera, a stereoscopic camera, an RGB camera, or any other type of optical sensor 230 that can capture images of the tension-induced features that are found on a thin film substrate and that may indicate that the manufacturing system 100 is in a fault state. As depicted in FIG. 3, the sensor 230 may be directed towards the thin film substrate to capture surface images and any tension-induced features formed thereon. In an example, the thin film monitoring system 102 may include, or be coupled to, multiple sensors 230 that are positioned at different locations throughout the manufacturing system 100 to capture images of the thin film substrate at different locations throughout the manufacturing system 100, such as a point immediately upstream of where the thin film substrates are joined together.

In any case, the output of the camera or other sensor 230 is stored as sensor data 214 in the data store 212 and may be used by the feature module 222 to identify features on the surface of the thin film substrates that may indicate out-of-range and/or asymmetric tension imparted upon the thin film substrate by the tension rollers of the manufacturing system 100.

In one embodiment, the data store 212 stores the sensor data 214 along with, for example, metadata that characterizes various aspects of the sensor data 214. For example, the metadata can include location coordinates (e.g., longitude and latitude), relative map coordinates or tile identifiers, time/date stamps from when the separate sensor data 214 was generated, and so on.

The data store 212 may further include a fault model 216, which may be relied on by the fault state module 224 to infer a fault state of the manufacturing system 100. The state of the manufacturing system 100 may be determined in a number of ways. As one example, the sensor data 214 may be compared against historical data for the manufacturing system 100 or another manufacturing system. That is, as described above, tension-induced features such as ridges, may manifest in the thin film substrate even when the thin film substrate is tensioned to a desired degree (i.e., within a threshold tension range). Changes to the applied tension value change the characteristics of the tension-induced ridges. For example, the longitudinal measure, lateral measure, quantity, depth, and/or angle of the ridges may change based on the tension. In this example, the fault state module 224 may determine that the manufacturing system 100 is in a fault state when the characteristics of the tension-induced features change by a threshold amount. In this example, the fault model 216 may include baseline data and/or images. The fault state module 224 may compare the currently collected images and/or data to the baseline images and/or data. If the deviation between one or more of the characteristics of the currently measured ridges differs from the respective baseline data by greater than a threshold amount (e.g., more than 10%, more than 20%, more than 30%), the fault state module 224 may output a fault state indicia.

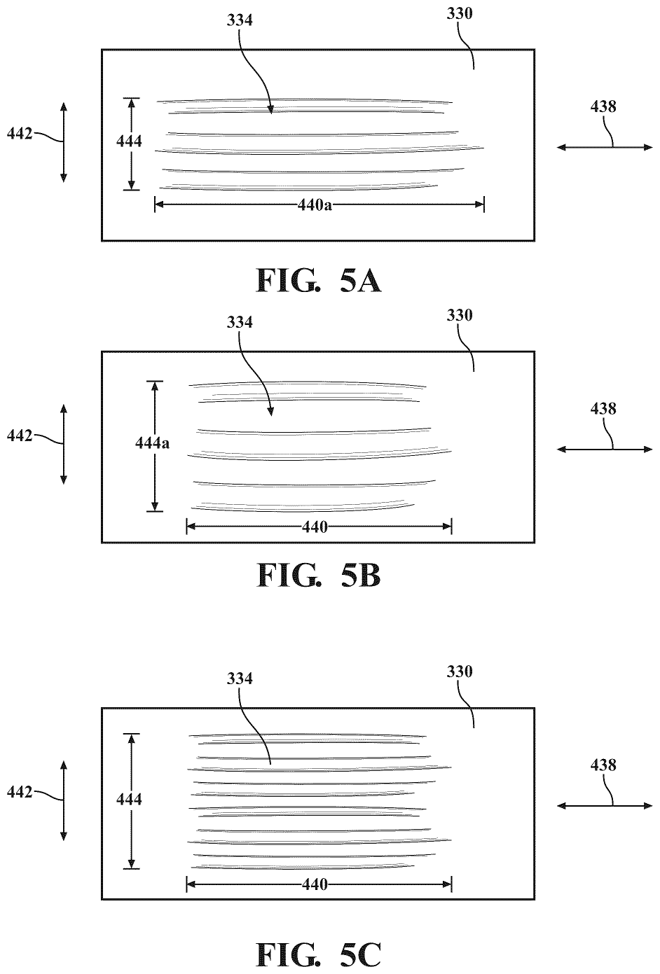

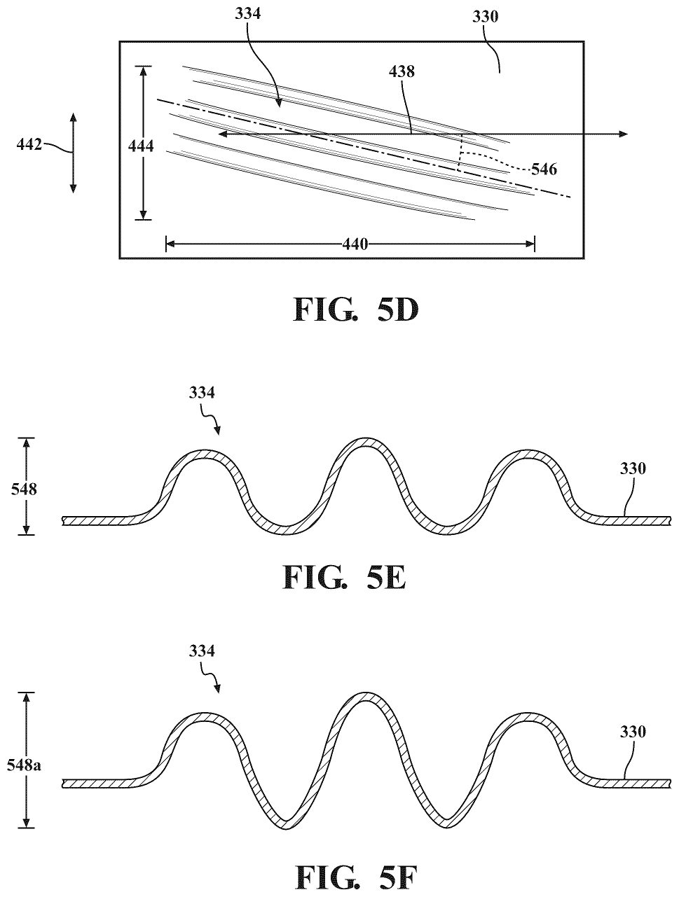

In an example, the baseline data in the fault model 216 may be specific to the manufacturing system 100. That is, a determination regarding a fault state for the manufacturing system 100 may be based, at least in part, on a deviation of current tension-induced features from expected tension-induced features. For example, as depicted in FIG. 5C, the angle of the currently measured ridges may differ from the angle of ridges measured when the manufacturing system 100 was deemed functioning as desired. As such, the fault model 216 may include a history of the characteristics of the tension-induced features to form a baseline against which currently measured ridge characteristics are compared to determine whether the manufacturing system is in a fault state.

In an example, the fault model 216 may include baseline data collected from other manufacturing systems, which in some examples may be received from a remote server or the other manufacturing systems via the communication system 228. As described above, the fault state module 224 may identify deviations of currently-measured tension-induced features from baseline patterns to identify a faulty manufacturing system 100 or process. In an example, such a comparison may be between currently-measured tension-induced features and baseline data from other manufacturing systems.

In another example, the fault state of the manufacturing system 100 may be determined based on a mapping between characteristics of the tension-induced features and fault states. That is, in the example above, a fault state was determined based on the change to the characteristics (e.g., length, width, depth, quantity, and angle) of the ridges. In another example, the fault state may be based on the characteristics rather than a temporal change to the characteristics. For example, it may be that a ridge angle of 5 degrees (from the longitudinal axis of the thin film substrate (i.e., a path of travel of the thin film substrate)) may indicate that the tension applied to the thin film substrate is asymmetric to a degree where intervention is desired to ensure product/process safety, efficiency, and consistency. In this example, the fault model 216 may include the mapping between fault states and measured values of the characteristics of the tension-induced features.

In one particular example, the fault model 216, in addition to including a mapping between the state of the manufacturing system 100 and the tension-induced feature characteristics, the fault model 216 may include a mapping between the tension-induced feature characteristics and a cause or source of the fault. For example, shorter ridges in the longitudinal direction may indicate a lower applied tension than longer ridges in the longitudinal direction. Accordingly, ridge characteristics, as measured by the feature module 222, that indicate a below-target applied tension may indicate the thin film substrate is slipping over one of the tension rollers. In this example, the fault model 216 may include a mapping between the measured feature characteristics such that the fault state module 224 may output a potential cause of the particular anomaly.

In another example, the thin film monitoring system 102 may be a machine-learning system. A machine-learning system generally identifies patterns and/or deviations based on previously unseen data. In the context of the present application, a machine-learning thin film monitoring system 102 relies on some form of machine learning, whether supervised, unsupervised, reinforcement, or any other type, to infer whether the manufacturing system 100 is in a fault state. In an example, the fault model 216 is a supervised model where the machine learning is trained with an input data set and optimized to meet a set of specific outputs. In another example, the fault model 216 is an unsupervised model where the model is trained with an input data set but not optimized to meet a set of specific outputs; instead, it is trained to classify based on common characteristics. As another example, the fault model 216 may be a self-trained reinforcement model based on trial and error.

In any case, the fault model 216 may include the weights (including trainable and non-trainable), biases, variables, offset values, algorithms, parameters, and other elements that operate to output an inference of a fault state of the manufacturing system 100 based on any number of input values including sensor data 214. Examples of machine-learning models include, but are not limited to, logistic regression models, Support Vector Machine (SVM) models, naïve Bayes models, decision tree models, linear regression models, k-nearest neighbor models, random forest models, boosting algorithm models, and hierarchical clustering models. While particular models are described herein, the fault model 216 may be of various types intended to classify the state of the manufacturing system based on sensor data 214.

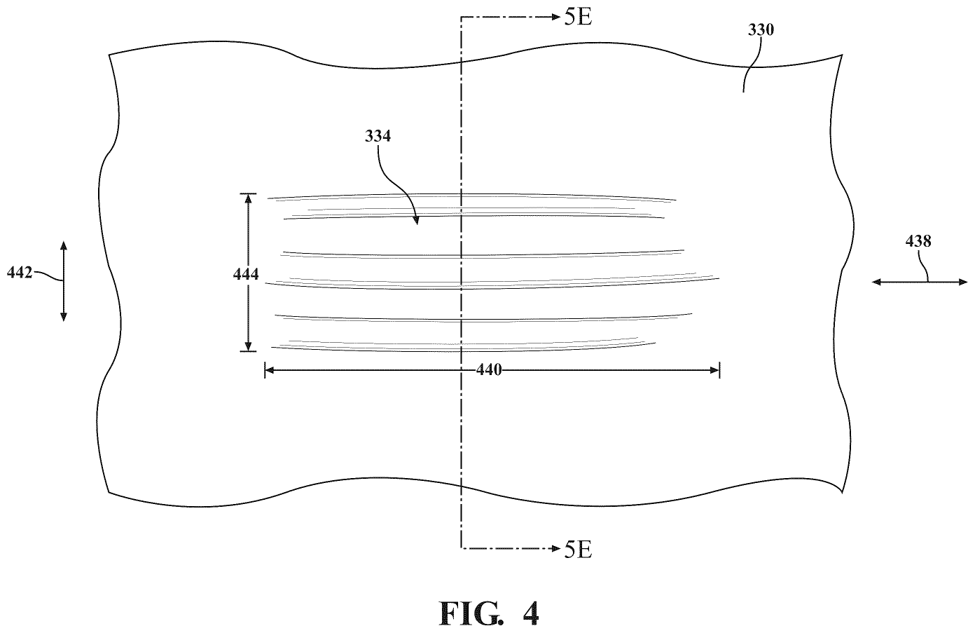

The thin film monitoring system 102 includes a feature module 222 which, in one embodiment, includes instructions that cause the processor 218 to identify, from an output of a sensor 230 directed toward a thin film substrate, a tension-induced feature on a surface of the thin film substrate that is under tension in a manufacturing system 100. As described above, as part of the manufacturing process, a thin film substrate is stretched longitudinally, which generates tension-induced features on the surface of the thin film substrate, such as ridges, as depicted in FIG. 4. Images or other output is captured by the sensor 230, stored in the data store 212, and processed by the feature module 222. That is, the feature module 222 may include instructions executable to identify features in a captured image. For example, ridges formed in a thin film substrate may reflect light differently than planar regions of the thin film substrate because of the angled surface against which light reflects. The feature module 222 may analyze this pixel-based information and differences therebetween to identify the ridges on the thin film substrate.

In addition to recognizing the ridges, the feature module 222 may identify the characteristics of the ridges or other tension-induced features on the surface of the thin film substrate. That is, the feature module 222 may measure the physical characteristics of the ridges, such as 1) the ridge length in a longitudinal direction, 2) the ridge width in a lateral direction, 3) the ridge depth in a direction perpendicular to a lateral and longitudinal direction, 4) a number of ridges in the film, and 5) a longitudinal angle of the ridges. As described above, the values associated with these measured characteristics or the change to such over time may indicate whether the associated manufacturing system 100 is in a fault state.

The thin film monitoring system 102 includes a fault state module 224 which, in one embodiment, includes instructions that cause the processor 218 to detect that the manufacturing system 100 is in a fault state based on a characteristic of the tension-induced feature. That is, the fault state module 224 receives the output of the feature module 222 and determines whether the currently measured characteristics and/or changes over time indicate a complication with the manufacturing system 100 and/or operation that should be addressed.

The fault state module 224 may include instructions that cause the processor to 1) identify an expected tension-induced feature characteristic on the surface of the thin film substrate, the expected tension-induced feature characteristic being associated with a target state for the manufacturing system and 2) compare the characteristic of the tension-induced feature of the thin film substrate to the expected tension-induced feature characteristic. That is, the expected tension-induced feature characteristic may be mapped to a desired tension range for the thin film substrate. Again, as described above, feature characteristics change based on the applied tension. Accordingly, a target tension range may be associated with particular feature target characteristics, and deviations from those characteristics may indicate something is amiss in the manufacturing system 100 and/or process.

The expected characteristics may have a variety of formats. In one example, the expected characteristics are historically collected characteristics that allow the fault state module 224 to infer the state of the manufacturing system 100. In this example, the fault state module 224 may compare the currently-measured characteristic data against historical data, which historical data values may reflect 1) historical characteristic values measured when the manufacturing system 100 was operating in a non-fault state, 2) historical characteristic values measured when the manufacturing system 100 was operating in a fault state, 3) historical characteristic values measured when another manufacturing system was operating in a non-fault state, or 4) historical characteristic values measured when another manufacturing system was operating in a fault state. In an example, the baseline data may be classified based on metadata associating the baseline data with the states of the recording manufacturing systems 100.

In this example, based on 1) the deviation between the currently measured tension-induced feature characteristics and the historical values associated with non-fault states and/or 2) the similarity between the currently measured tension-induced feature characteristics and the historical values associated with fault states, the fault state module 224 may infer a fault state of the manufacturing system. That is, the fault state module 224 may include instructions that cause the processor 218 to detect that the manufacturing system 100 is in the fault state responsive to the characteristic of the tension-induced feature differing from the expected tension-induced feature characteristic by a threshold amount. As described above, such a comparison may be of at least one of a depth of ridges in the thin film substrate, a width of the ridges, a length of the ridges, a longitudinal angle of the ridges, or a number of ridges with corresponding expected tension-induced feature characteristics.

For example, a ridge on the surface of a thin film substrate may change with regard to any of these characteristics in various ways based on whether an applied tension exceeds or falls below a target range. The fault state module 224, by comparing the measured characteristics determined by the feature module 222 against the historical data, may classify the characteristics as indicative of a fault state, identify the fault state (e.g., over-tension, under-tension, asymmetric tension), and in some cases identify the source of the fault. As a specific example, a currently measured length of the ridges greater than an expected (e.g., historical) value by more than a threshold degree may indicate that the thin film substrate is experiencing over-tension (e.g., under a tension load that is greater than the target tension).

In another example, the expected values may be those that map to non-fault states and/or fault states. For example, it may be known, via the fault model 216, that for a given manufacturing system 100 or a similar but different manufacturing system, a ridge width of between 10-20% of the width of the thin film substrate is expected during target operation and that a ridge with that is less than 10% or greater than 20% may indicate an over or under tensioning of the thin film substrate. In this example, the value of the characteristic, rather than its temporal change, may be the expected value against which a currently-measured value is compared to determine fault. Similar to the above example, the fault state module 224 compares the currently measured tension-induced feature characteristics against the expected values (in this case measured values mapped to known fault states) to infer the fault state of the manufacturing system 100. Whatever data is included in the fault model 216 (e.g., historical patterns of the monitored manufacturing system, historical patterns of additional manufacturing systems, fault-mapped data), the fault state module 224 infers a fault state of the manufacturing system 100.

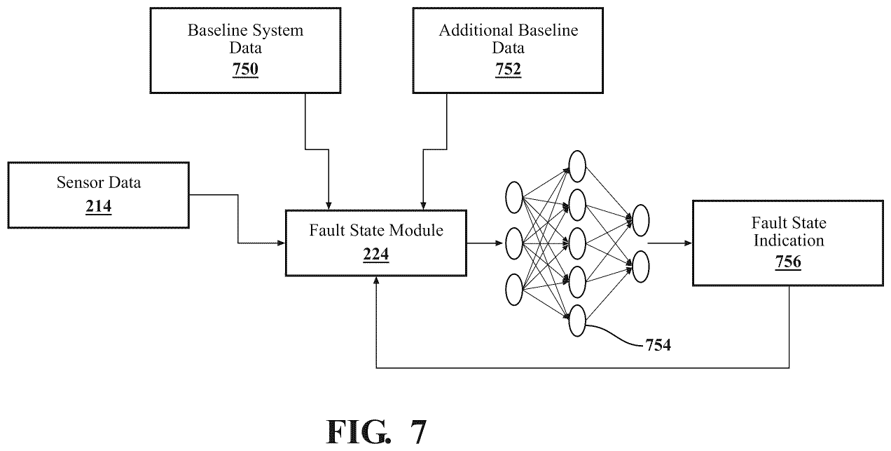

In one approach, the fault state module 224 is a machine-learning module. That is, the fault state module 224 may include instructions that cause the processor 218 to detect, using a machine-learning operation, that the manufacturing system 100 is in a fault state. That is, the fault state module 224 may implement and/or otherwise use a machine learning algorithm. A machine-learning algorithm generally identifies patterns and deviations based on previously unseen data. In the context of the present application, a machine-learning fault state module 224 relies on some form of machine learning, whether supervised, unsupervised, reinforcement, or any other type of machine learning, to identify patterns in ridge characteristics and infer whether the manufacturing system 100 is in a fault state based on the sensor data 214 and the fault model 216. As such, as depicted in FIG. 7, the inputs to the fault state module 224 include the sensor data 214 and the baseline data. The fault state module 224 relies on a mapping between feature characteristics and fault states, determined from the training set, which includes baseline data, to determine the likelihood of impaired manufacturing based on the measured characteristics.

In one configuration, the machine learning algorithm is embedded within the fault state module 224, such as a convolutional neural network (CNN) or an artificial neural network (ANN) to perform manufacturing system state classification over the sensor data 214. Of course, in further aspects, the fault state module 224 may employ different machine learning algorithms or implement different approaches for performing the hearing impairment inference, which can include logistic regression, a naïve Bayes algorithm, a decision tree, a linear regression algorithm, a k-nearest neighbor algorithm, a random forest algorithm, a boosting algorithm, and a hierarchical clustering algorithm among others to generate state classifications. Other examples of machine learning algorithms include but are not limited to deep neural networks (DNN), including transformer networks, convolutional neural networks, recurrent neural networks (RNN), Support Vector Machines (SVM), clustering algorithms, Hidden Markov Models, and so on. It should be appreciated that the separate forms of machine learning algorithms may have distinct applications, such as agent modeling, machine perception, and so on.

Whichever particular approach the fault state module 224 implements, the fault state module 224 improves thin film substrate handling by introducing machine-learning processing of hundreds, thousands, or millions of pieces of data. For example, the fault state module 224 may receive information from hundreds of manufacturing systems. Through machine learning, this complex data, which would be impossible to process otherwise, is processed to identify patterns against which measured tension-induced feature characteristics are compared. Thus, machine learning enables a more accurate inference of the manufacturing system state. In this way, the fault state module 224 identifies manufacturing system states that may negatively impact the product (e.g., battery), life, safety, or performance such that appropriate remedial actions may be performed to reduce the likelihood of these situations.

Moreover, it should be appreciated that machine learning algorithms are generally trained to perform a defined task. Thus, the training of the machine learning algorithm is understood to be distinct from the general use of the machine learning algorithm unless otherwise stated. That is, the thin film monitoring system 102 or another system generally trains the machine learning algorithm according to a particular training approach, which may include supervised training, self-supervised training, reinforcement learning, and so on. In contrast to training/learning of the machine learning algorithm, the thin film monitoring system 102 implements the machine learning algorithm to perform inference. Thus, the general use of the machine learning algorithm is described as inference.

It should be appreciated that the fault state module 224, in combination with the fault model 216, can form a computational model such as a neural network model. In any case, the fault state module 224, when implemented with a neural network model or another model in one embodiment, implements functional aspects of the fault model 216 while further aspects, such as learned weights, may be stored within the data store 212. Accordingly, the fault model 216 is generally integrated with the fault state module 224 as a cohesive, functional structure. Additional details regarding the machine-learning operation of the fault state module 224 and fault model 216 are provided below in connection with FIG. 7.

In addition to detecting the state of the manufacturing system 100, the fault state module 224 may include instructions that cause the processor 218 to identify a source of the fault state based on the characteristic of the tension-induced feature. For example, an asymmetric angle of the ridge pattern may indicate that an upstream tension roller is applying unequal tension across the width of the thin film substrate. In this example, the fault state module 224 may analyze the characteristics of the tension-induced features, as measured by the feature module 222, to identify the source of the fault state.

The thin film monitoring system 102 includes a remedial action module 226 which, in one embodiment, includes instructions that cause the processor 218 to execute a remedial action responsive to the manufacturing system 100 being in the fault state. That is, were the manufacturing system 100 allowed to operate in a fault state, the manufacturing system 100 may become damaged and/or produce faulty products (e.g., lithium-ion battery cells 110). Accordingly, the remedial action module 226 performs any number of remedial actions to address the fault state. In an example, the remedial action may include 1) generating a notification, 2) halting the operation of the manufacturing system 100, and/or 3) adjusting an operation of the manufacturing system 100 based on the characteristic of the tension-induced feature. As an example, the notification may be presented via a user interface of the manufacturing system 100 or to a computing device coupled to the manufacturing system 100. In another example, the remedial action module 226 may provide a signal to components of the manufacturing system 100 to halt or change operation based on a detected state. For example, in an example where it is determined that tension is too great on a particular thin film substrate between two tension rollers, the remedial action module 226 may generate a signal that adjusts the manufacturing system (e.g., adjusting the position of different tension rollers) to reduce the tension thereon.

In any case, the thin film monitoring system 102 may be coupled to a communication system 228 to facilitate communication with 1) coupled electronic devices and/or components of the manufacturing system 100. It is through this communication system 228 that the thin film monitoring system 102 may receive the sensor data 214 and that control signals and/or notification signals are transmitted to the manufacturing system 100 and/or controlling user interface.

In one embodiment, the communication system 228 communicates according to one or more communication standards. For example, the communication system 228 can include multiple different antennas/transceivers and/or other hardware elements for communicating at different frequencies and according to respective protocols. The communication system 228, in one arrangement, communicates via a communication protocol, such as WiFi, DSRC, or another suitable protocol for communicating with the manufacturing system 100 or other devices. In another example, the communication system 228 may be a wired connection system.

FIG. 3 illustrates one embodiment of a thin film monitoring system 102 that is associated with identifying manufacturing system 100 defects with respect to the handling of thin film substrates 330. As described above, thin film substrates 330 may be found in many electronic products, including lithium-ion battery cells 110, such as those found in the batteries of electric vehicles. During manufacturing, the thin film substrates 330 are unwound from spools and transported under tension along several tension rollers 332-1, 332-2, and 332-3 of a manufacturing system 100. For simplicity, a few instances of tension rollers 332-1, 332-2, and 332-2 are depicted in FIG. 3 while a manufacturing system 100 may have any number of these tension rollers. Also as described above, a ridge pattern 334 may form on the surface of the thin film substrate 330 as a physical relic of maintaining the thin film substrate 330 under tension. Particular characteristics of the ridge pattern 334, or changes in the ridge pattern 334 over time, may indicate whether the tension rollers 332-1, 332-2, and 332-3 induce too much, too little, or asymmetric tension. Accordingly, the thin film monitoring system 102 includes, or as in the example depicted in FIG. 3 is coupled to, a sensor 230, such as a camera 336 that is directed to the thin film substrate 330. The camera 336 captures images of the thin film substrate 330, and the thin film monitoring system 102 analyzes the images as described above to 1) identify tension-induced features on the surface of the thin film substrate 330 (e.g., ridge patterns 334) and 2) infer a state of the manufacturing system 100 (e.g., fault state or non-fault state) based on the characteristics of the tension-induced features. As described above, the thin film monitoring system 102 may include instructions that cause the processor 218 to identify the tension-induced feature (e.g., ridge pattern 334) on a surface of at least one of an anode thin film substrate 104, a cathode thin film substrate 106, or a separator thin film substrate 108 of a lithium-ion battery cell 110. However, a thin film monitoring system 102 may detect such on any thin film besides those used in lithium-ion battery cells 110.

FIG. 4 illustrates an example of an expected tension-induced feature of a thin film substrate 330. As described above, tension-induced features on a thin film substrate 330, such as a ridge pattern 334, may be expected even when the manufacturing system 100 operates within target manufacturing operating parameters. These features may be defined, in part, by a number of physical characteristics. Examples include a number of ridges in the ridge pattern 334. In the example depicted in FIG. 4, there are five ridges, although there may be other quantities. Another example is the length 440 of the ridge pattern 334 in a longitudinal direction 438. In an example, the longitudinal direction 438 may be the direction of travel of the thin film substrate 330 through the manufacturing system 100. Another example is the width 444 of the ridge pattern 334 in a lateral direction 442. In an example, the lateral direction 442 may be a direction perpendicular to the direction of travel of the thin film substrate 330 through the manufacturing system 100. The width 444 of the ridge pattern 334 may be defined as a measurement unit (e.g., centimeters, millimeters, etc.) or as a percentage of the width of the thin film substrate 330. Another example is the angle of the ridge pattern 334 relative to a reference axis, such as the longitudinal direction 438. The ridge pattern 334 in FIG. 4 has an angle of 0, given its parallel alignment with the longitudinal direction 438. Another example is the depth of the ridges in the ridge pattern 334. FIGS. 5E and 5F depict a cross-sectional view of the ridge pattern 334 to illustrate the depth of the ridges.

As described above, variation of any or a combination of these characteristics may indicate a manufacturing system 100 and/or process complication identified and addressed by the thin film monitoring system 102.

FIGS. 5A-5F illustrate examples of fault-indicating tension-induced surface features of a thin film substrate 330. First, as depicted in FIG. 5A, the feature module 222 may determine that the length 440a of the ridge pattern 334 is different than previously measured by a threshold amount or different than a fault-mapped expected value. The fault state module 224 may evaluate such to infer that the manufacturing system 100 is in a fault state, and the remedial action module 226 may execute a number of remedial actions (e.g., generate a notification, halt production, and/or adjust operating parameters of the manufacturing system 100) based on the measured difference.

As depicted in FIG. 5B, the feature module 222 may determine that the width 444a of the ridge pattern 334 is different than previously measured by a threshold amount or different than a fault-mapped expected value. The fault state module 224 may evaluate such to infer that the manufacturing system 100 is in a fault state, and the remedial action module 226 may execute a number of remedial actions (e.g., generate a notification, halt production, and/or adjust operating parameters of the manufacturing system 100) based on the measured difference.

As depicted in FIG. 5C, the feature module 222 may determine that there are a different number of ridges in the ridge pattern 334 as compared to previously measured quantities or a fault-mapped expected value. The fault state module 224 may evaluate such to infer that the manufacturing system 100 is in a fault state, and the remedial action module 226 may execute a number of remedial actions (e.g., generate a notification, halt production, and/or adjust operating parameters of the manufacturing system 100) based on the measured difference.

As depicted in FIG. 5D, the feature module 222 may determine that the ridge angle 546, measured from the longitudinal direction 438, is different than previously measured by a threshold amount or different than a fault-mapped expected value. The fault state module 224 may evaluate such to infer that the manufacturing system 100 is in a fault state, and the remedial action module 226 may execute a number of remedial actions (e.g., generate a notification, halt production, and/or adjust operating parameters of the manufacturing system 100) based on the measured difference.

FIG. 5E depicts a cross-section of the thin film substrate 330 taken along the line 5E from FIG. 4. As described above, in addition to a length 440 and a width 444, the ridges of the ridge pattern 334 may be defined by a depth 548, which may be defined as a direction perpendicular to the longitudinal direction 438 and the lateral direction 442. As with the other ridge pattern 334 characteristics, the depth 548 of the ridges may indicate whether the manufacturing system 100 is in a fault state.

As depicted in FIG. 5F, the feature module 222 may determine that the depth 548a of the ridge pattern 334 is different than previously measured by a threshold amount or different than a fault-mapped expected value. The fault state module 224 may evaluate such to infer that the manufacturing system 100 is in a fault state, and the remedial action module 226 may execute a number of remedial actions (e.g., generate a notification, halt production, and/or adjust operating parameters of the manufacturing system 100) based on the measured difference.

While FIG. 5A-5F depict specific fault-indicating feature characteristics, the thin film monitoring system 102 may identify other or different combinations of features indicative of the fault state of the manufacturing system 100. Moreover, the threshold amount by which the state of the manufacturing system 100 is classified may vary and be selected based on any number of criteria. For example, the threshold amount may be 10%, 20%, 30%, 40% or the like. Moreover, different threshold values may be associated with different characteristic comparisons, with different characteristics being compared to their respective expected values and evaluated against different threshold metrics. That is to say, the thin film monitoring system 102 of the present specification provides customization into the evaluation and classification of the manufacturing system 100 state.

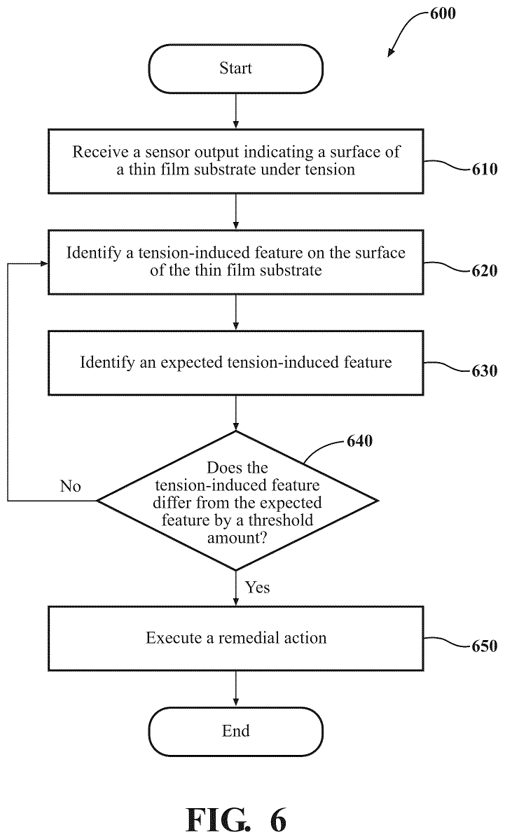

Additional aspects of monitoring thin film handling in a manufacturing system 100 will be discussed in relation to FIG. 6. FIG. 6 illustrates a flowchart of a method 600 that is associated with monitoring tension-induced thin film features to determine manufacturing and product quality. Method 600 will be discussed from the perspective of the thin film monitoring system 102 of FIGS. 1-3. While method 600 is discussed in combination with the thin film monitoring system 102, it should be appreciated that the method 600 is not limited to being implemented within the thin film monitoring system 102 but is instead one example of a system that may implement the method 600.

At 610, the thin film monitoring system 102 receives a sensor output indicating a surface of a thin film substrate 330 under tension. As described above, sensors 230, such as cameras 336, may be placed at various locations within a manufacturing system 100 to capture images of the surface of the thin film substrates 330 transported therethrough.

At 620, the feature module 222 identifies, from an output of the sensor 230, a tension-induced feature on the surface of the thin film substrate 330. For example, the feature module 222 may be a machine-vision system that can detect the ridges that manifest on the thin film substrate 330 due to the tensioning of the thin film substrate 330 through the manufacturing system 100. In addition to detecting the ridges, the feature module 222 may also identify the characteristics of the thin film substrate 330, such as the ridge pattern 334 that may form on the surface of the thin film substrate 330.

At 630, the thin film monitoring system 102, and more particularly the fault state module 224, may identify an expected tension-induced feature characteristic. As described above, this expected characteristic may represent a threshold range about a particular value associated with the manufacturing system 100 operating in a non-fault state. For example, the ridge pattern 334 may have specific characteristics when operating within a target tension range of 0.05 to 0.20 MPa. These characteristics may be determined empirically based on historical data collected from the monitored manufacturing system 100 or another manufacturing system (e.g., baseline data). In this example, the expected tension-induced feature characteristics may be those that deviate from the target tension range-associated characteristics by less than a threshold amount (e.g., by 10%, 20%, 30%, etc.). Deviations greater than the threshold amount may indicate a tension that is greater than or less than the target tension range by an amount that is associated with reduced performance, lifespan, or safety to a degree deemed unsuitable by a manufacturer.

In another example, the expected tension-induced feature characteristic may be a fault-mapped characteristic. That is, historical baseline data (from either the monitored manufacturing system 100 or another) may indicate that a ridge angle 546 of greater than 5% may lead to manufacturing jams, sub-optimal battery performance, or any other product/manufacturing complication. Accordingly, in the previous example, the measured characteristic change is measured, while in the present example, the measured characteristic value itself is considered.

In either case, at 640, the fault state module 224 determines whether the measured tension-induced feature differs from an expected feature by a threshold amount. If not, the feature module 222 and fault state module 224 continue to monitor the manufacturing operations and/or manufacturing system 100. If the measured tension-induced feature does differ from the expected feature characteristic by a threshold amount, at 650, the remedial action module 226 executes a remedial action such as generating a notification, halting production, and/or adjusting the operating parameters of the manufacturing system 100 to align with the target tension. As such, the method 600 facilitates the early detection of manufacturing system 100 complications that may lead to sub-optimal products and manufacturing operation inefficiencies, thus facilitating the alleviation of the negative implications of such (e.g., reduced performance, lifespan, and safety and manufacturing downtimes).

FIG. 7 illustrates one embodiment of a machine-learning thin film monitoring system 102. Specifically, FIG. 7 depicts the fault state module 224, which in one embodiment with the fault model 216, administers a machine learning algorithm to generate a fault state indication 756, which fault state indication 756 triggers the execution of a remedial action.

As described above, the machine-learning model may take various forms, including a machine-learning model that is supervised, unsupervised, or reinforcement-trained. In one particular example, the machine-learning model may be a neural network 754 that includes any number of 1) input nodes that receive sensor data 214, 2) hidden nodes, which may be arranged in layers connected to input nodes and/or other hidden nodes and which include computational instructions for computing outputs, and 3) output nodes connected to the hidden nodes which generate an output indicative of the fault state of the manufacturing system 100.

As described above, the fault state module 224 relies on baseline data to infer a fault state of the manufacturing system 100. Specifically, the fault state module 224 may acquire baseline system data 750 and additional baseline data 752 (i.e., collected from other systems). The baseline data may be characterized as whether it represents fault or non-fault states. The baseline data may reflect both of these conditions, and the fault state module 224, whether supervised, unsupervised, or reinforcement-trained, may detect similarities between the sensor data 214 with the patterns identified in the baseline system data 750 and additional baseline data 752.

As stated above, the fault state module 224 considers different deviations and generates an inference. However, as each deviation from baseline data may not conclusively indicate a fault state, the fault state module 224 may consider and weights different deviations when generating the inference.

In any example, if the deviation is greater by some threshold than the baseline data, the fault state module 224 outputs an indication, which indication may be binary or graduated. For example, if the frequency, quantity, and degree of deviation surpass a threshold, the fault state module 224 may indicate that the manufacturing system 100 is in a fault state. By comparison, if the frequency, quantity, and degree of deviation do not surpass the threshold, the fault state module 224 may indicate that the manufacturing system is not in a fault state. In another example, the output may indicate a degree of the fault, which may be determined based on the frequency, quantity, and degree of deviation of the sensor data 214 from the baseline data.

In any case, the indication 756 may be passed to the fault state module 224 to refine the machine-learning algorithm. For example, a user may be prompted to evaluate the indication provided. This user feedback may be transmitted to the fault state module 224 so that future inferences can be generated based on the correctness of past inferences. That is, feedback from the user or other source may be used to refine the fault state module 224 to more accurately infer the manufacturing system 100 state based on measured sensor data 214.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
identify, from an output of a sensor directed towards a thin film substrate, a tension-induced feature on a surface of the thin film substrate that is under tension in a manufacturing system;
detect that the manufacturing system is in a fault state based on a characteristic of the tension-induced feature; and
execute a remedial action responsive to the manufacturing system being in the fault state.

2. The system of claim 1, wherein the machine-readable instruction that causes the processor to identify the tension-induced feature on the surface of the thin film substrate comprises a machine-readable instruction that causes the processor to identify the tension-induced feature on at least one of an anode thin film substrate surface, a cathode thin film substrate surface, a or separator thin film substrate surface, for a lithium-ion battery cell.

3. The system of claim 1, wherein the machine-readable instruction that causes the processor to detect that the manufacturing system is in the fault state comprises machine-readable instructions that cause the processor to:
identify an expected tension-induced feature characteristic on the surface of the thin film substrate, the expected tension-induced feature characteristic is associated with a target state for the manufacturing system; and
compare the characteristic of the tension-induced feature of the thin film substrate to the expected tension-induced feature characteristic.

4. The system of claim 3, wherein the machine-readable instructions further comprise a machine-readable instruction that causes the processor to detect that the manufacturing system is in the fault state responsive to the characteristic of the tension-induced feature differing from the expected tension-induced feature characteristic by a threshold amount.

5. The system of claim 3, wherein the machine-readable instruction that causes the processor to compare the characteristic of the tension-induced feature of the thin film substrate to the expected tension-induced feature characteristic comprises a machine-readable instruction that causes the processor to compare at least one of a depth of ridges in the thin film substrate, a width of the ridges, a length of the ridges, a longitudinal angle of the ridges, or a number of ridges to corresponding expected tension-induced feature characteristics.

6. The system of claim 1, wherein the machine-readable instruction that causes the processor to detect that the manufacturing system is in the fault state comprises an instruction that causes the processor to detect, using a machine-learning operation, that the manufacturing system is in the fault state.

7. The system of claim 1, wherein the machine-readable instruction that causes the processor to execute the remedial action comprises a machine-readable instruction that causes the processor to perform at least one of:
generating a notification;
halting operation of the manufacturing system; or
adjusting an operation of the manufacturing system based on the characteristic of the tension-induced feature.

8. The system of claim 1, wherein the machine-readable instructions further comprise a machine-readable instruction that, when executed by the processor, causes the processor to identify a source of the fault state based on the characteristic of the tension-induced feature.

9. A system, comprising:
a manufacturing system comprising tension rollers that apply tension to a thin film substrate;
a sensor directed towards the thin film substrate to capture data associated with the thin film substrate traveling under tension through the manufacturing system;
a processor; and
a memory storing machine-readable instructions that, when executed by the processor, cause the processor to:
identify, from an output of the sensor, a tension-induced feature on a surface of the thin film substrate;
detect that the manufacturing system is in a fault state based on a characteristic of the tension-induced feature; and
execute a remedial action responsive to the manufacturing system being in the fault state.

10. The system of claim 9, wherein:
the manufacturing system further comprises a system to combine an anode thin film substrate, a cathode thin film substrate, and a separator thin film substrate into a lithium-ion battery cell; and
the machine-readable instruction that causes the processor to identify the tension-induced feature on the surface of the thin film substrate comprises a machine-readable instruction that causes the processor to identify the tension-induced feature on at least one of the anode thin film substrate surface, the cathode thin film substrate surface, or the separator thin film substrate surface.

11. The system of claim 9, wherein the machine-readable instruction that causes the processor to detect that the manufacturing system is in the fault state comprises machine-readable instructions that cause the processor to:
identify an expected tension-induced feature characteristic on the surface of the thin film substrate, the expected tension-induced feature characteristic is associated with a target state for the manufacturing system;
compare the characteristic of the tension-induced feature of the thin film substrate to the expected tension-induced feature characteristic; and
detect that the manufacturing system is in the fault state responsive to the characteristic of the tension-induced feature differing from the expected tension-induced feature characteristic by a threshold amount.

12. The system of claim 11, wherein the machine-readable instruction that causes the processor to compare the characteristic of the tension-induced feature of the thin film substrate to the expected tension-induced feature characteristic comprises a machine-readable instruction that causes the processor to compare at least one of a depth of ridges in the thin film substrate, a width of the ridges, a length of the ridges, a longitudinal angle of the ridges, or a number of ridges with corresponding expected tension-induced feature characteristics.

13. The system of claim 9, wherein the machine-readable instruction that causes the processor to detect that the manufacturing system is in the fault state comprises an instruction that causes the processor to detect, using a machine-learning operation, that the manufacturing system is in the fault state.

14. The system of claim 9, wherein the machine-readable instructions further comprise a machine-readable instruction that, when executed by the processor, causes the processor to identify a source of the fault state based on the characteristic of the tension-induced feature.

15. A method, comprising:
identifying, from an output of a sensor, a tension-induced feature on a surface of a thin film substrate that is under tension in a manufacturing system;
detecting that the manufacturing system is in a fault state based on a characteristic of the tension-induced feature; and
executing a remedial action responsive to the manufacturing system being in the fault state.

16. The method of claim 15, wherein identifying the tension-induced feature on the surface of the thin film substrate comprises identifying the tension-induced feature on at least one of an anode thin film substrate surface, a cathode thin film substrate surface, or a separator thin film substrate surface, for a lithium-ion battery cell.

17. The method of claim 15, wherein detecting that the manufacturing system is in the fault state comprises:
identifying an expected tension-induced feature characteristic on the surface of the thin film substrate, the expected tension-induced feature characteristic is associated with a target state for the manufacturing system;
comparing the characteristic of the tension-induced feature of the thin film substrate to the expected tension-induced feature characteristic; and
detecting that the manufacturing system is in the fault state responsive to the characteristic of the tension-induced feature differing from the expected tension-induced feature characteristic by a threshold amount.

18. The method of claim 17, wherein comparing the characteristic of the tension-induced feature of the thin film substrate to the expected tension-induced feature characteristic comprises comparing at least one of a depth of ridges in the thin film substrate, a width of the ridges, a length of the ridges, a longitudinal angle of the ridges, or a number of ridges with corresponding expected tension-induced feature characteristics.

19. The method of claim 15, wherein detecting that the manufacturing system is in the fault state comprises detecting, using a machine-learning operation, that the manufacturing system is in the fault state.

20. The method of claim 15, further comprising identifying a source of the fault state based on the characteristic of the tension-induced feature.
